(19) United States
(12) Patent Application Publication
(10) Pub. No.: US 2011/0271173 A1
(43) Pub. Date: Nov. 3, 2011

(54) Method and apparatus for automatic filling of forms with data

(75) Inventors: Salah Aït-Mokhtar, Meylan (FR); Ágnes Sándor, Meylan (FR)

(73) Assignee: Xerox Corporation, Norwalk, CT (US)

(21) Appl. No.: 12/772,655

(22) Filed: May 3, 2010

(51) Int. Cl. G06F 17/20

(52) U.S. Cl. 715/226

(57) ABSTRACT

A system and a method for filling a form are provided which take as input a user's data file, which is configured for use in filling in forms, and an image of an original form to be filled in using the user's personal data. Form filling rules encoded in the image are decoded and used to determine values of a plurality of fields of the form by applying the decoded rules to the user's data. The plurality of fields of the form are filled with the determined values to generate an at least partially filled form, which is then output, e.g., to a printer or a display. The exemplary system and method are able to operate independently of the language used in the text of the form, have the capability of filling in previously unseen forms, and are particularly suited to filling in paper forms.

### BACKGROUND

The exemplary embodiment relates to a system and method for auto-completion of forms. It finds particular application in connection with the importing of a user's personal data into appropriate fields of a form.

People often need to fill in different pre-printed administrative forms with their personal data, such as name, address, date of birth, place of birth, passport ID, and the like. This can be a repetitive and time-consuming task since the paper forms are often filled in manually by the user. Subsequently, the data is manually entered into computer databases by administrative employees. Much of the information required by the forms is common among paper forms of different administrations/organizations and countries.

Automatic fill-in systems exist for filling in electronic forms especially in web pages. However, they generally require that the user manually fill in the same web page in a previous session, or that the field names in the form to be filled in match predefined field names stored in a user profile file. Such systems are thus dependent on the field names of the form, and in particular on the language used.

A number of commercially available software packages propose filling in paper forms automatically. In one method, a paper document is scanned and filled in digitally. In other systems, automated methods are used for recognizing fields.

None of these systems allow the user's data to be imported into many different forms where the field names are quite different from those previously encountered by the system.

### INCORPORATION BY REFERENCE

The following references, the disclosures of which are incorporated herein by reference in their entireties are mentioned:

U.S. Pat. No. 5,794,259, issued Aug. 11, 1998, entitled APPARATUS AND METHODS TO ENHANCE WEB BROWSING ON THE INTERNET, by Dan Kikinis discloses a system for filling fields in Internet forms which associates stored fill entities with field names and places the stored fill entities into fields in the Internet form.

U.S. Pat. No. 6,192,380, issued Feb. 20, 2001, entitled AUTOMATIC WEB BASED FORM FILL-IN, by John Light, et al., discloses a method which includes recognizing a form in a web page, identifying information to be filled into the form, determining whether data corresponding to the information to be filled into the form is authorized by a user to be disclosed to the web page, and automatically filling the data into the form from a database if the data is authorized by the user to be disclosed to the web page.

U.S. Pat. No. 6,928,623, issued Aug. 9, 2005, entitled METHOD AND SYSTEM FOR SELECTING A TARGET WINDOW FOR AUTOMATIC FILL-IN, by Mark A. Sibert, discloses a data processing system in which a user of a GUI can easily designate one of a plurality of windows to be automatically filled in with predetermined, pre-stored information. A method and system are disclosed for selection of a target window from among a plurality of open windows so that the target window can be used for an application specific function, such as for the directing of digital wallet information to the target window only.

U.S. Pat. No. 5,640,577, issued Jun. 17, 1997, entitled DATA PROCESSING SYSTEM WITH AUTOMATED AT LEAST PARTIAL FORMS COMPLETION, by Andrew J. Scharmer, discloses a data processing system for automated forms generation which uses data displayed at a predetermined position on a data terminal display screen and a data processing function selector to automatically retrieve a pre-established form stored in a data processing system. The data processing system retrieves data from at least one data field displayed on the screen and automatically inserts the data in a predetermined uncompleted field of the form.

U.S. Pat. No. 7,254,569, issued Aug. 7, 2007, entitled INTELLIGENT AUTOFILL, by Goodman, et al., discloses a system and method that can employ machine learning techniques to automatically fill one or more fields across a diverse array of web forms. Machine learning can be used to learn what data corresponds to which fields or types of fields.

The following publications disclose hand-held optical information readers for optically reading a target based on a light reflected from the target, suitable for reading dataglyphs, data matrix codes, and QR codes: U.S. Pub. Nos. 20050040237, 20060175411, and 20060196942.

The following references relate generally to the incorporation of glyphs in documents: U.S. Pat. Nos. 5,091,966, 5,128,525; 5,168,147; 4,716,438; 4,728,984; 4,757,348; 4,970,554, 5,060,980, 5,157,726, 5,221,833; 5,245,165; 5,278,400; 5,315,098; 5,317,646, 5,448,375, 5,449,895; 5,449,896, 5,453,605, 5,489,763, 5,521,372; 5,537,223; 5,572,010; 5,576,532; 5,611,575; 5,684,885; 5,706,099; 5,717,197; 5,761,686 and 5,771,245.

### BRIEF DESCRIPTION

In accordance with one aspect of the exemplary embodiment, a method for filling a form includes receiving a user's personal data configured for use in filling in forms, receiving an image of an original form to be filled in using the user's personal data. With a processor, form filling rules encoded in the image are decoded. Values of a plurality of fields of the form by are determined by applying the decoded rules to the user's data. The plurality of fields of the form is autofilled with the determined values to generate an at least partially autofilled form. The at least partially filled in form is output.

In another aspect, a system for automatically filling in forms includes a rule decoder which decodes auto-filling rules which have been encoded in a paper form, a rule interpreter which applies the decoded rules to pre-saved user personal data to identify values for fields of the form, a form filler which enters the values in respective fields of the form, whereby the form is at least partially filled in, and a computer processor which implements the rule decoder, rule interpreter, and form filler.

In another aspect a combination includes a user's personal data file in which data items are associated with nodes of a tree structure and a scanned form comprising fields to be filled in based on the user's data file, the scanned form encoding autofilling rules which, when decoded, specify filing value expressions for determining values for the fields based on the data items associated with specified ones of the nodes of the user's data file and without reference to any of the text associated with fields of the scanned form.

### BRIEF DESCRIPTION OF THE DRAWINGS

FIG. 1 is an overview of a system and method for auto-filling forms;

FIG. 2 is a functional block diagram of an apparatus for auto-filling forms;

FIG. 3 is a flow diagram of a for auto-filling forms; and

FIG. 4 illustrates an exemplary XML user data file as a tree structure.

### DETAILED DESCRIPTION

Aspects of the exemplary embodiment relate to a method and system for form filling which can be performed entirely or at least partially automatically. In various aspects, the method is independent of the language used, has the capability of filling in previously unseen forms, and enables filling in of paper forms.

Briefly, data values for a person or persons (name, date of birth, etc.) are saved in a structured digital data file. Paper forms issued by organizations or administrations contain, in their header and/or footer, auto-filling rules, which may be encoded as DataGlyphs, Data matrix codes, QR codes, and the like. Each auto-filling rule indicates which user's data item should be used to generate a value to fill a specified field/region in the paper form and how the value is to be generated from the data item, e.g. input directly, combined, modified, or only used if a condition is met. When a user has to fill in a paper form, the user provides it to a scanning device for a form-filling system, along with his or her pre-saved data file. The system fills in the scanned paper form based on the auto-filling rules it contains and the user's data.

The system finds particular application in relation to administrative paper forms generated by a particular organization or government body where the issuing organization uses the same method(s) for encoding the auto-filling rules in all or a number of their paper forms. If a common encoding method becomes widely accepted across organizations/governments, it may become universally applicable.

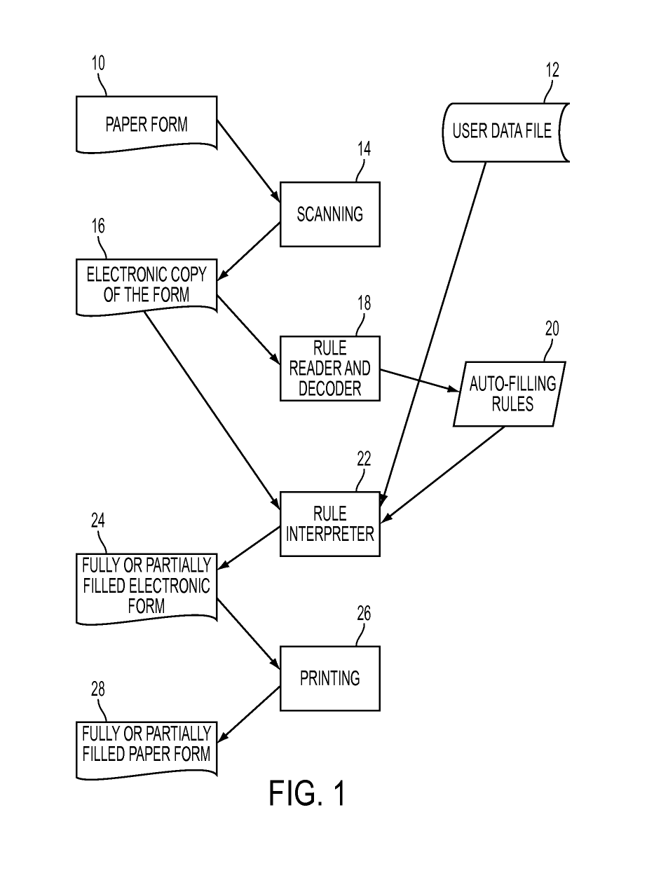

FIG. 1 provides an overview of a system and method for populating paper forms 10 with user data that is stored electronically in a user data file 12. The paper form 10 is scanned by a scanner 14 to produce an electronic copy 16 of the form. A rule decoder 18 extracts autofilling rules 20 from the electronic copy 16. A rule interpreter 22 applies the autofilling rules 20 to the user's data in the data file 12 to determine data for filling in fields of the form which is used to generate a fully or partially filled electronic form 24. The partially filled electronic form 24 may be sent to a printer 26 for printing a hardcopy 28 of the form 24 or stored for further processing by the user.

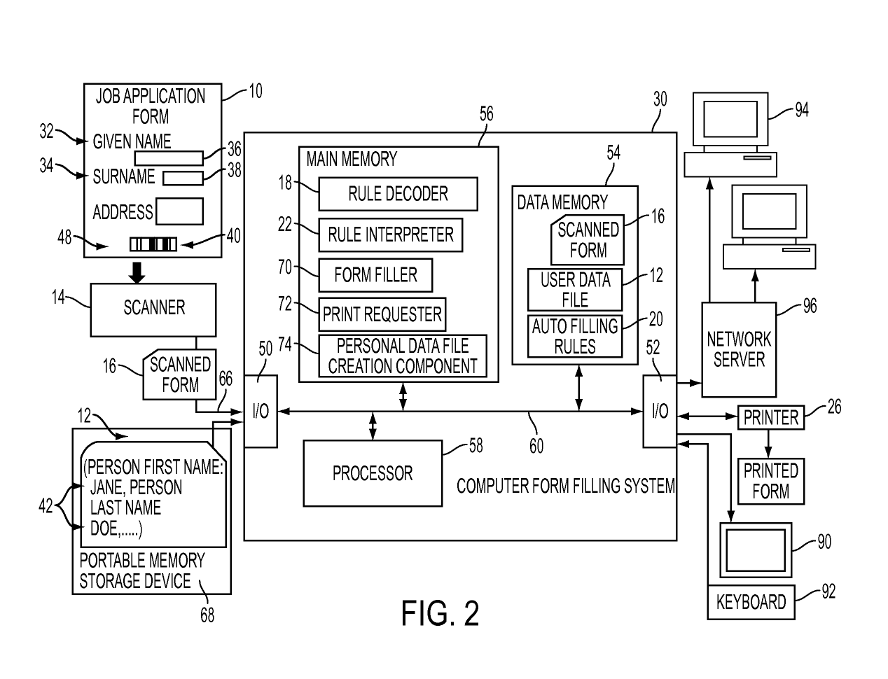

FIG. 2 is a functional block diagram which illustrates one embodiment of a computer system 30 for populating (filling in) paper forms with user data 12. A typical “blank” (unfilled) form 10 includes printed text serving as field descriptions 32, 34, etc., and associated blank fields 36, 38, etc., which are intended to be filled in by a person. Each paper form 10 also encodes one or more auto-filling rules 20, encoded as machine readable data 40, which is printed on the form 10. Each auto-filling rule identifies, for one of the form's fields 36, 38, a filling value expression specifying which of the user's data 42 in the data file 12 should fill the respective field in the paper form on which the information to be inserted into the field is to be based. In the illustrated example, one of the auto-filling rules may specify that field 36, which on the paper form has a field description 32 “given name,” is to be filled in with the user data string constant with the value person/name/firstname, and another of the auto-filling rules may specify that field 38, which on the paper form has a field description 34 “Surname,” is to be filled in with the user data string constant with the value person/name/lastname, with the requirement that the text all be in capital letters. The machine readable data 40 may thus encode filling value expressions for some or all the fields 36, 38, etc. of the form. The encoding is independent of the field description 32, 34 on the form, which can be in any language or format. For example, “given name” could be replaced with “first name,” the French word “prenom,” or the like, without affecting the encoding.

A designated location 48 on the form 10, such as in a header or footer region, includes the auto-filling rules as machine readable data 40, such as a graphical encoding. Exemplary forms of graphical encoding include barcodes, DataGlyphs and QR codes or any other efficient machine readable encoding. Dataglyphs generally encode information into very small, individual glyph elements. Each element may consist of a small 45 degree diagonal line, about 0.025 cm in length, or less, depending on the resolution of the printing and scanning that is used. Each line represents a single binary 0 or 1, depending on whether it slopes to the left or right. Sequences of these lines can be used to encode numeric, textual, or other information. QR codes are two dimensional codes, such as matrix codes or two dimensional bar codes. The code 40 may also include locations of the data fields, e.g., their x,y coordinates. Alternatively, the system 30 may identify each of the designated fields from the scanned form and determine its x,y coordinates, with the fields then being autofilled in a predefined order, such as left to right and then top to bottom.

The user data file 12 may include such information 42 as name, date of birth, address, and the like. As noted above, each data item of the user's data is a value of a string constant, described in greater detail below.

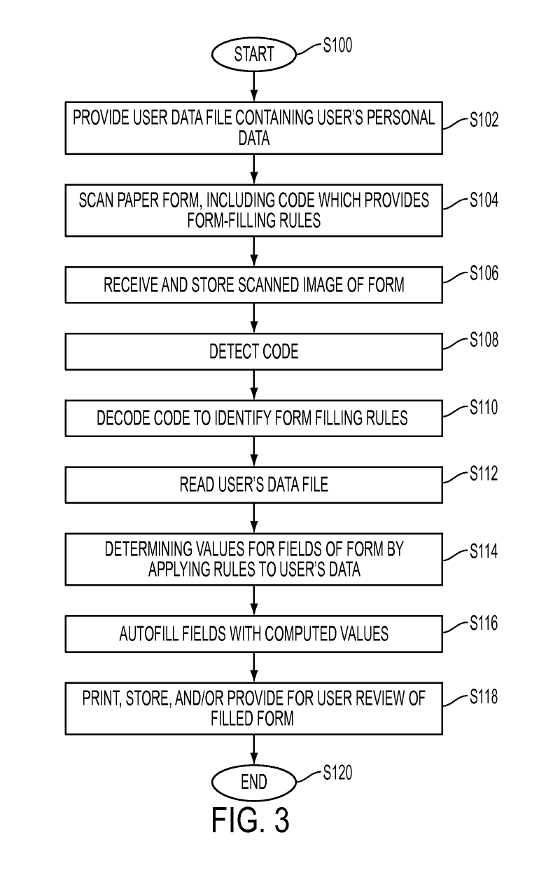

The form filling system 30 may be in the form of hardware or a combination of hardware and software. The illustrated system 30 is in the form of a computing device with one or more inputs/outputs 50, 52, for communicating with external devices, data memory 54, main memory 56, and a digital processor 58, all connected by a data/control bus 60. System 30 may include one or more computing devices, such as a general purpose computer or dedicated computing device, such as a desktop or laptop computer, PDA, web-based server, network server, handheld computing device, or the like. The exemplary processor 58 controls the overall operation of the system 30 by execution of processing instructions which are stored in main memory 56 connected to the processor as well as executing instructions for implementing the method described with reference to FIG. 3. In the exemplary embodiment, memory 56 stores software instructions which are executed by processor 58.

In one embodiment, the computer system 30 is hosted by a multifunction device which includes a scanner 14 and a printer 26. For example, the digital front end (DFE) of the multifunction device includes a CPU which controls the scanning and printing functions of the device and also serves as the processor 58. In other embodiments, the system 30 is resident in a scanner 14.

The memory 54, 56 can include random access memory (RAM), read-only memory (ROM), a hard disk, optical disk, combinations thereof, and the like, and may be physically located in the same computing device or parts thereof may be accessible to the computing device, e.g., via a local area network or the Internet.

The digital processor 58 can be variously embodied, such as by a single-core processor, a dual-core processor (or more generally by a multiple-core processor), a digital processor and cooperating math coprocessor, a digital controller, or the like.

Scanned forms 16 to be processed by system 30 are received by input 50 from a scanning device 14 via a wired or wireless link 66 and may be stored in a volatile portion of memory 54 during processing. In one embodiment, scanning device 14 forms a part of the system 30. In other embodiments, scanner 14 and computer system 30 are separate units.

The system 30 may access the user data 42 stored as a digital file either internally, e.g., in memory 54, or externally, e.g., accessible from a USB connection, Ethernet, Internet or any wireless connection (e.g., Bluetooth connection with the user's mobile phone where the user's data are stored in memory). For example, the data file 12 may be stored on portable data memory 68, such as a disk or USB memory device. In other embodiments, the user's data file 12 is encoded in hardcopy on print media, such as on a sheet of paper or a card. The data file may be encoded as QR codes, Dataglyphs, Data matrix codes, barcodes, or the like or may simply be a printed XML file understandable by an XML reader. The paper/card may thus be provided to the system scanning device 14 along with the paper form 10 to be filled in. The system causes the scanning device 14 to scan the user's data paper/card. In either case, the system 30 decodes his/her personal data and then applies the auto-filling rules to fill in the paper form.

In a typical scanning device 14, a document sheet is illuminated with light from a light source and the light reflected from the document sheet is recorded by a photosensitive device such as a CCD (charge coupled device) or CMOS (complementary metal oxide semiconductor) array, to be converted to digital image data. In one embodiment, a narrow strip of the document sheet is illuminated as the sheet is moved through a document handler, or the photosensitive device is moved relative to a platen on which the document sheet is placed. Exemplary scanning devices for scanning encoded datglyphs or QR codes encoding the auto-fill rules are disclosed, for example, in U.S. Pub. Nos. 20050040237, 20060175411, 20060196942, the disclosures of which are incorporated by reference in their entireties.

The system 30 may include various processing components including a rule decoder 18, a rule interpreter 22, a form filler 70, and a print requester 72, which operate on an input scanned form 16. Components 18, 22, 70, and 72 may be in the form of hardware or software and may operate on the output of a prior one of the components. In the illustrated embodiment, these components are in the form of software instructions stored in memory 48 which are executed by the processor 52. Operation of these components is best understood with reference to the method described in greater detail below. Briefly, rule decoder 18 identifies the encoding 40 of the form filling rules on the scanned form and decodes it to generate the autofilling rules. The rule interpreter 22 applies the form filling rules to the user's data file to generate values to be input to some or all of the fields. The form filler 70 inputs the values to the appropriate fields. The print requester 72 receives the at least partially filled in form and sends it to the printer 26 for printing a hardcopy of the auto-filled form. The printer 26 prints the at least partially filled in form on print media, such as paper, using a marking material, such as ink(s) in the case of an inkjet printer, or toner particles in the case of a laser printer. The exemplary system 30 also includes a user data file creation component 74, for creating and modifying a user's data file, although in other embodiments the component 74 may be separately located and executed by a separate processor.

The output 52 of the computer system 30 may be linked to a display 90, such as an LCD screen or computer monitor, which allows a user to review the filled form prior to printing, e.g., by printer 26. The exemplary display 90 is directly linked to computer 30. A user may edit the displayed at least partially filled form prior to printing, using an associated user input device 92, such as a keyboard, touch screen, cursor control device, or combination thereof. However, in other embodiments, the display may be associated with a client computing device 94, linked to the system 30 by a wired or wireless link 96, such as cable, a local area network, or a wide area network, such as the Internet. The client computing device 94 may include a web browser which displays a user data file interface with a user data file creation component 98 of the system 30.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 3 illustrates the exemplary method which may be performed with the system of FIG. 2. The method begins at S100.

At S102 data 42 for one or more people which are to be used in filling in forms 10 is provided in a markup language file 12, such as an eXtended Markup Language (XML) file, and stored in memory.

At S104, a paper form 10 to be filled in is provided, e.g. by an organization or administration. The form includes printed text 32, 34 and associated blank fields 36, 38 which are intended to be filled in by a person, e.g., by handwriting, although in the exemplary embodiment, one or more of the fields is autofilled. Each paper form 10 also encodes one or more auto-filling rules as a code 40, as noted above.

At S106, when a user wishes to fill in a paper form, the form is scanned by a suitable scanning device 14 to generate a scanned image 16, optionally along with his/her personal data file 12, if this is encoded on paper. Standard methods for deskewing the image and ensuring that the scanned image corresponds in size and shape to the original form may be used, such as providing marks on the paper form which are spaced by predefined distances.

At S108, the system receives the scanned image 16 and detects the encoded information 40, which includes the auto-filling rules and encoded locations of the data fields.

At S110, the auto-filling rules and filed locations are decoded.

At S112, the user's data file is retrieved and read by the system.

At S114, for each auto-filling rule, the system looks up the required user data in the user's data file, computes the value of the expression of the rule and at S116, with this value, fills in the corresponding form region specified by the rule. If a rule requires a user data element that is not available in the user data file, the rule is ignored and the corresponding field region is left empty.

At S118, the system sends the at least partially completed form to the printer which prints out the fully or partially filled form or otherwise outputs the form. In one embodiment, the data is automatically stored in a database which is used for storing data entered on the organization's paper forms.

The method ends at S120.

The method can be repeated using the same user's file to fill in a very different form.

The exemplary method is able to provide several advantages over conventional systems for filling in paper forms. It can save time and effort for the user who may have to fill in several different paper forms per year, often with similar information. It can also save time and effort for administrations/organizations since their paper forms are filled in more rapidly and with better coherence and fewer errors. Additionally, the automatically filled-in data can be automatically read (through the embedded auto-filling rules and OCR) and inserted into the organization's computer databases. The exemplary method also has the advantage of being independent of the language of the paper form and of its field names. It enables wide variations in form field names and in required value formats among organizations and countries. The method is thus more robust than existing methods used for the filling of electronic (web) forms which are based on exact or fuzzy-matching of field names.

The encoded forms 10 can be provided as a service to an organization by an outside service provider which is provided with sample forms to be filled in and reformats the forms to include a code 40, using an encoding system which defines the appropriate form filling rules for the particular form. The encoding system, which may be similarly configured to system 30, may use an algorithm to generate form filling rules based on answers to questions posed to an operator who answers based on reading the text of the sample form. In one embodiment, a service provider may provide a service for scanning paper forms and entering data in the fields based on a supplied user data file and optionally uploading the entered data to the organization's database.

The method illustrated in FIG. 3 may be implemented in a computer program product that may be executed on a computer. The computer program product may be a tangible computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method for populating a paper form.

Further details of the system and method follow.

### The User Data File

In the exemplary embodiment, the user's data are stored in standardized data structure format, e.g., an XML-based format. XML is a tree-like data structure for a document, here, a user's data file, where XML nodes refer to the junction of branches of the tree-like structure. Each node in the XML document contains the (string) value of one data item of the user data that is referred to by the Xpath of the node. XPath is a node-tree data model and path expression language for selecting data within XML documents. An XPath expression points to an address within an XML document where data may be located. XPath makes it possible to refer to individual parts of an XML document. XPath expressions can refer to all or part of the data in XML nodes. The root node of an XML document refers to the entire document.

For instance, the Xpath expression /person/name/lastname will refer to the family name of the person, and /person/name/firstname to the first name of the person, while /person/birth/date/year refers to the year of the date of birth of the person.

The user data are expressed with fine granularity so that the auto-filling rules of the system can refer to precise data items when appropriate for a given form. For example, any date value is split into basic components (day, month_noun, month_number, year) so that an auto-filling rule can access them and build a date string in any format and with the required date components. For example, one form may have a field for the person's birth date in the format mm/dd/yyyy, another requires the format dd/mm/yyyy, while yet another may require only the year of birth yyyy.

The user's personal data file 12 may be created and updated by the user through a local or web-based friendly graphical user interface (GUI) which avoids the need for the user to edit XML data.

Once completed or updated, the data file can be saved, for example, on a disk, a USB storage device, a PDA, a mobile phone, or on a paper or card, encoded as DataGlyphs or QR codes, or stored in a database accessible to the system.

In general, all user data files use the same standardized tree structured format, the primary difference between a personal data file for user A and a data file for user B is in the data items which are associated with respective ones of the nodes. In some embodiments, the user's data file may only include nodes corresponding to part of a generic tree structure which is generic to all user data files, such that any nodes which are not present are read as having a NULL data item.

In some embodiments, not all the nodes of the standardized data structure may have an associated data item, for example, if the user does not want to provide this information. In some embodiments, the data file may be submitted with certain nodes locked, (or the associated data encrypted) and therefore the associated data item(s) are inaccessible to the system 30. This may be used for sensitive information which the user does not want to provide to all administrative organizations. For example, the generic tree structured format may have the option to enter a credit card number as the data item for one of the nodes, with the option of locking this node from access by the system/encrypting the data item, which is only decoded when a user's password is entered.

### Auto-Filling Rules

The auto-filling rules infer the same tree structure as is used in creation of the user data file so that a node of the tree structure can be specified in the auto-filling rules, with the knowledge that a specific data item that has been associated by the user (or the creation component) with that node will be retrieved.

Each auto-filling rule follows predefined syntax and semantics. For example, an auto-filling rule may be expressed in the following format:

<form_field_region>: <filling_value_expression>

where:
<form_field_region> is the coordinates (x₁,y₁,x₂,y₂) of the top left corner point and bottom right corner point of the field region to be filled in the paper form, for a particular form field. The coordinates are expressed in a distance measure unit, e.g., millimeters or pixels. If the fields are the same size, only one reference point need be identified.
<filling_value_expression> is an expression built in a selection language, such as XPath, referring to XML nodes in the user data file, string constants, string operators, and if-then-else statements.

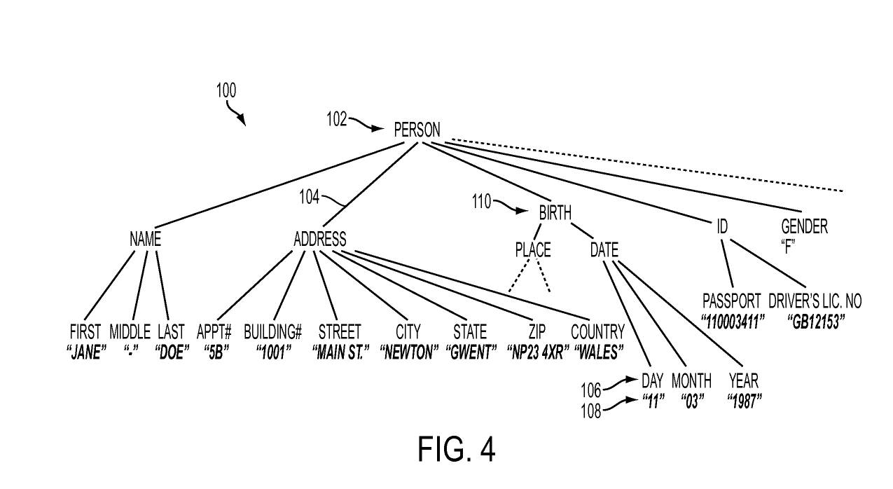

For example as illustrated in FIG. 4, the users data can be expressed as a tree 100 in which a root node 102 is linked by paths 104 to terminal nodes 106 which each have a data item 108 associated with them and which may be spaced from the root node by one or more intermediate nodes 110, which have no data associated with them. The user's data, comprising all the data items, is thus distributed over the terminal nodes. A string constant generally corresponds to the data item 108 from a terminal node in the user's data tree.

A string operator defines how the string constant is modified before insertion in the form 16, for example, the string operator may specify that the string constant is to be in upper case. If-then-else-statements may be used to define a condition, which if met, results in the form region being filled in with string constant data, as modified by the string operator, else left blank, as the case may be (or it may specify that the form region is filled in with other data, such as a check mark, or the word YES or NO).

The syntax and semantics of filling value expressions (FVEs) can be defined as follows:

1. Any string constant written between beginning and end quotes, such as “and”, is an FVE, and its string value is the constant itself.

2. Any Xpath string is an FVE and its value is the content of the first matching XML node in the user data file. If such node does not exist, then the value of the FVE is NULL.

3. If A is an FVE, then A[i], where i is an integer, is an FVE and its value is the ith character of the string value of A (0 refers to the first position). If i is greater or equal the length of A, then the value of A[i] is NULL. If the value of A is NULL, then A[i] is NULL.

4. If A is an FVE, then A[i,j] (where i>j) is an FVE and its value is the substring of the value of A laying from the ith character up to the jth character. If i is greater or equal the length of A, then the value of A[i,j] is NULL. If the value of A is NULL, then A[i,j] is NULL.

5. If A is an FVE, then UPPER(A) is an FVE and its value is the value string of A where every alphabetic character in lowercase is replaced by its uppercase counterpart. If the value of A is null, then UPPER(A) equals NULL.

6. If A and B are two FVEs, then A+B is an FVE and its value is the concatenation of the string value of A and the string value of B, in this order. If A or B equals NULL, then A+B equals NULL.

7. If A, B, X and Y are FVEs, then IF (A=B; X; Y) is an FVE and its value is NULL if A is NULL, the value of X if A equals B, the value of Y otherwise.

As will be appreciated, the syntax defining rules are not limited to the seven syntax rules shown above. The rules may be added to, modified, or reduced in number.

Auto-Filling Rule Interpretation

The system may interpret an auto-filling rule as follows:

1. The (string) value of the FVE of the rule is computed.

2. If the value equals NULL or “ ” (the empty string), the system ignores the rule, otherwise, it adds the string value to the form field region (of the electronic form copy 16) specified in the auto-filling rule, using adequate font and size attributes to fit in the region.

### Examples of Auto-Filling Rules

Some example rules are as follows:

1. (100,120,170,128): UPPER(/person/name/lastname)

This rule tells the system to print the uppercase form of the user's last name in the region specified by the upper left and lower right coordinates listed in the format (x₁,y₁,x₂,y₂). The specified region corresponds to a field to fill in, labeled, for example, with “Family name” or “Surname”, which, as noted above, has no relevance to the operation of the exemplary method. This is an example of the syntax and semantics rule noted at 3 above. The instruction LOWER can be used to put a value in lower case.

2. (100,120,170,128): if(/person/gender=“Male”; “X”; NULL)

This rule tells the system to print an “X” in (i.e., to check) the specified region if the user's gender is “Male”, nothing otherwise. It is assumed that the specified region corresponds to a field to check that is labeled, for example, “M” or “Male”. This is an example of the operation of an If-then-else-statement in an FVE.

3. (150,120,157,127): if(/person/gender=“Female”; “X”; NULL)

This rule tells the system to print an “X” in (i.e., to check) the specified region if the user's gender is “Female”, nothing otherwise. It is assumed that the specified region corresponds to a field to check labeled, for example, with “F”, “female” or “femelle”. This is an example of the operation of an If-then-else-statement in an FVE.

4. (170,120,190,130): (/person/name/firstname)[0]

This rule inserts the first initial of the user's first name in the specified field region, e.g., the letter J in the case of the data structure shown in FIG. 4. This is an example of the syntax and semantics rule noted at 3 above.

5. (100,120,170,150): UPPER(/person/address/country)[0,2]

This rule inserts the first three letters of the country where the user lives in the specified field region, in upper case, e.g., the letters WAL in the case of the data structure shown in FIG. 4. This is an example of the syntax and semantics rules noted at 4 and 5 above.

6. (150,120,170,150): /person/birth/date/month+“/”+/person/birth/date/day+“/”+/person/birth/date/year

This rule inserts the month day and year of the user's birth in the specified field region e.g., the date Mar. 11, 1987 in the case of the data structure shown in FIG. 4. As specified in the syntax and semantics rule at 6, above, this rule will enter a NULL value if any of the three nodes specified is empty.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for filling a form comprising:
receiving a user's personal data configured for use in filling in forms;
receiving an image of an original form to be filled in using the user's personal data;
with a processor, decoding form filling rules encoded in the image;
determining values of a plurality of fields of the form by applying the decoded rules to the user's data;
autofilling the plurality of fields of the form with the determined values to generate an at least partially autofilled form; and
outputting the at least partially autofilled form.

2. The method of claim 1, wherein the outputting the at least partially form comprises printing the form with the autofilled fields.

3. The method of claim 1, wherein each of a plurality of the autofilling rules define a form field region which identifies a location of a field to be filled and a filling value expression which provides a rule for determining the value of the field, based on at least one identified piece of the user's data.

4. The method of claim 3, wherein the filling value expressions are generated from the group consisting of:
at least one string constant which retrieves a specified piece of user data;
a string operator which defines how the at least one string constant is modified before insertion in the form;
an if-then-else rule which defines how the field is to be filled if a condition is met and how the field is to be treated if the condition is not met; and
combinations thereof.

5. The method of claim 3, wherein the user's personal data comprises a tree-structured document in which the user's data is distributed among nodes of the tree, each piece of the user's data being independently retrievable as a string constant value.

6. The method of claim 5, wherein the user's data comprises an extended markup language file.

7. The method of claim 5, wherein at least one filling value expression comprises an Xpath expression for retrieving a data item of the user's data.

8. The method of claim 5, wherein the user's data includes at least one of a name, an address, and a date of birth of the user and wherein the at least one of the name, address, and date of birth is distributed over a plurality of nodes, whereby a part of the name, address, or data of birth is retrievable as the value of a string constant.

9. The method of claim 3, wherein the decoding comprises decoding a graphical encoding printed on the original form.

10. The method of claim 8, wherein the graphical encoding is selected at least one of a barcode, a DataGlyph, a QR code, and a Datamatrix.

11. The method of claim 1, wherein the receiving the user's personal data comprises receiving a pre-saved file.

12. The method of claim 1 wherein a first rule is associated with a first of the fields and at least a second, different rule is associated with a second of the fields.

13. The method of claim 1, wherein the form filling rules are executed without taking into consideration text that is associated with the fields of the form.

14. The method of claim 1, further comprising scanning the original form to generate the image of the original form.

15. The method of claim 1, wherein the user's data is configured for filling in multiple forms of different types, with different fields, independent of any language in which text of the form is expressed.

16. A computer program product comprising tangible media encoding instructions, which when executed on a computer causes the computer to perform the method of claim 1.

17. A system for automatically filling in forms comprising:
memory which stores instructions for performing the method of claim 1 and a processor in communication with the memory for executing the instructions.

18. A system for automatically filling in forms comprising:
a rule decoder which decodes auto-filling rules which have been encoded in a paper form;
a rule interpreter which applies the decoded rules to pre-saved user personal data to identify values for fields of the form;
a form filler which enters the values in respective fields of the form, whereby the form is at least partially filled in; and
a computer processor which implements the rule decoder, rule interpreter, and form filler.

19. The system of claim 18, wherein each of a plurality of auto-filling rules comprises a field region defined with its coordinates and a filling value expression, which is built from at least one item of the user data, and optionally at least one of a string constant, a string operator and an if-then-else statement.

20. The system of claim 18, wherein the auto-filling rules are encoded and printed in the form to be filled in.

21. The system of claim 18, wherein the user personal data are stored in an XML-format, and where the auto-filling rules refer to specific items of user data using Xpath notation.

22. The system of claim 18, further comprising a scanning device which scans the paper form.

23. The system of claim 18, further comprising a printer which prints the at least partially filled form.

24. In combination:
a user's personal data file in which data items are associated with nodes of a tree structure; and
a scanned form comprising fields to be filled in based on the user's data file, the scanned form encoding autofilling rules which, when decoded, specify filing value expressions for determining values for the fields based on the data items associated with specified ones of the nodes of the user's data file and without reference to any of the text associated with fields of the scanned form.
